(19) United States
(12) Patent Application Publication
(10) Pub. No.: US 2026/0183727 A1
(43) Pub. Date: Jul. 2, 2026

(54) Mixing Paddle With Replaceable Wear Resistant Element

(71) Applicant: Kennametal Inc., Latrobe, PA (US)

(72) Inventors: Pavel Ledyan, Latrobe, PA (US); Thomas J. Long, Latrobe, PA (US); Jacob A. Poremski, Latrobe, PA (US); Robert J. Davison, Latrobe, PA (US); John D. Robertson, Latrobe, PA (US); Hugo G. Serrano, Latrobe, PA (US)

(73) Assignee: Kennametal Inc., Latrobe, PA (US)

(21) Appl. No.: 19/004,767

(22) Filed: Dec. 30, 2024

(51) Int. Cl. B01F 27/052; B01F 27/053; B01F 27/112

(52) U.S. Cl. CPC B01F 27/052; B01F 27/053; B01F 27/112

(57) ABSTRACT

An element or impeller includes a main body adapted to be operatively connected to a material processing machine, and a tip removably attached to the main body. The body and the tip define a first lateral side including a leading edge adapted to impact a material to be mixed, and a second lateral side opposite the first lateral side. A plurality of mounting elements removably fix the tip to the body. At least a portion of the mounting elements extend through the body from the second lateral side and engage with the tip.

### FIELD OF THE INVENTION

The present disclosure relates to material processing devices, and more specifically, to a material processing element, such as an impeller, hammer, blade or paddle having at least one removeable element.

### BACKGROUND

Mixing, blending, comminution and classification operations, by way of example, are common in material processing and manufacturing across a wide variety of industries and applications. These processes may be performed by hand or by machine, and may utilize various modes of agitation to blend material (e.g., rotation, vibration, etc.) As an example, mixing machines often implement rotating or otherwise moving elements or impellers, such as paddles or blades, to merge materials together. Due to the often harsh properties of the material(s) being mixed, as well as operational parameters (e.g., mixing time, speed, etc.), wear on these elements may be substantial. As a result, the elements must be replaced with significant frequency. In addition to being costly, the routine replacement of these elements can be time consuming, and thus limiting to overall processing output and efficiency.

Additionally, wear on the elements may not be uniform, as operational forces acting thereon tend to be highest on the leading edges and distal ends thereof. Thus, replacing an entire element may be unnecessarily wasteful. Likewise, the mechanical and physical requirements for certain features or areas of the mixing element may be distinct from others. In this way, a monolithic element, as found in the prior art, may not be optimal. For example, for strength and corrosion resistance in a primary body and mounting area of the element (e.g., where the element is attached to a rotating spindle of a machine), a material such as stainless steel may be preferred. In distinction, it may be desired to form a tip, end and/or leading edge of the element from a harder and/or more wear resistant material, such as cemented tungsten carbide.

Accordingly, improved elements addressing the above drawbacks are desired.

### SUMMARY

According to an embodiment of the present disclosure, an element, such as an impeller or an impeller assembly, includes a main body adapted to be operatively connected to a material processing machine, and a tip removably attached to the main body. The body and the tip define a first lateral side including a leading edge adapted to impact a material to be mixed, and a second trailing lateral side opposite the first lateral side. A plurality of mounting elements removably fix the tip to the body. At least a portion of the mounting elements extend through the body from the second lateral side and engage with the tip.

### BRIEF DESCRIPTION OF THE DRAWINGS

The invention will now be described by way of example with reference to the accompanying Figures, of which:

FIG. 1 is a top view of an exemplary element, impeller, blade, or paddle according to an embodiment of the present disclosure;

FIG. 2 is a partial top view of the element of FIG. 1 illustrating a main body, a removeable and/or replaceable tip thereof, and a fastening system or means;

FIG. 3 is a partial perspective view of the main body of the element of the preceding figures with the tip removed therefrom;

FIG. 4 is a partial perspective view of the tip of the element of the preceding figures;

FIG. 5 is a partial top view of an exemplary element, including a main body and removeable and/or replaceable tip thereof according to another embodiment of the present disclosure;

FIG. 6 is a partial perspective view of the main body of the element of FIG. 5;

FIG. 7 is a perspective view of the tip of the element of FIG. 5;

FIG. 8 is a partial top view of an exemplary element, including a main body and removeable and/or replaceable tip thereof according to another embodiment of the present disclosure;

FIG. 9 is a partial perspective view of the main body of the element of FIG. 8;

FIG. 10 is a perspective view of the tip of the element of FIG. 8;

FIG. 11 is a partial top view of another exemplary element, including a main body and removeable and/or replaceable tip thereof according to an embodiment of the present disclosure; and

FIG. 12 is a partial top view of another exemplary element, including a main body and removeable and/or replaceable tip thereof according to an embodiment of the present disclosure.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Embodiments of the present disclosure include a rotating element, impeller, paddle, or blade adapted to be mounted to a machine (e.g., to a rotating output thereof). The element includes a main body formed from a first material, such as stainless steel, and at least one replaceable end or tip removably attached thereto. The replaceable end may be formed from a second material, distinct from the first material, such as cemented tungsten carbide. The end defines at least a portion of a leading edge or working surface of the element that is adapted to be in contact with the material(s) during operation (e.g., mixing, dispersing, milling, etc.) In one exemplary embodiment, the end is secured to the main body via one more fastening means or fasteners, or a fastener system including a plurality of fasteners. More specifically, the main body defines a fastener opening extending therethrough. The fastener opening includes an open first end distal to the replaceable end and adapted to receive a fastener, and an open second end formed through, or opening on, a mating face of the body. The fastener opening of the main body is aligned with a corresponding opening or bore formed in the replaceable end (e.g., a threaded opening formed into an insert embedded in the replaceable end). The fastener is adapted to be inserted into the first end of the fastener opening of the main body, and engage with the opening in the replaceable end. Engagement (e.g., threading) of the fastener with the replaceable end is adapted to draw the end into abutting contact with the main body, selectively securing it thereto.

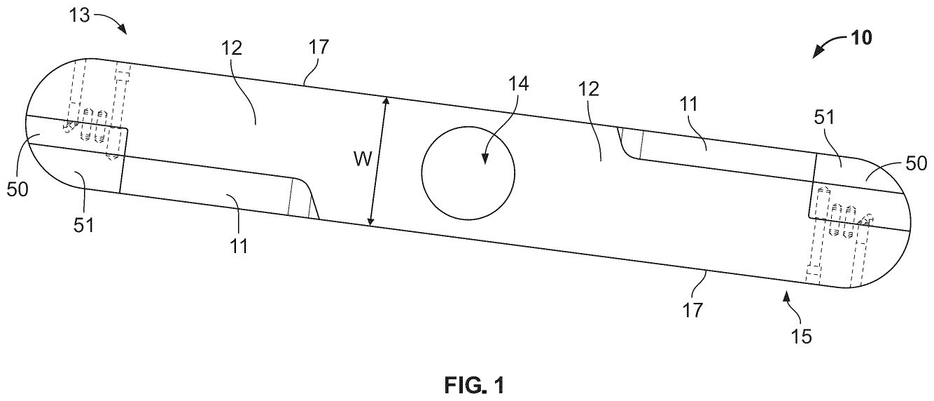

Referring generally to FIG. 1, a simplified exemplary element, impeller, paddle, or blade 10 is shown. The element 10 includes a main body 12 and a pair of removeable and/or replaceable ends or tips 50. The element 10 may be described as having two sides 13, 15 arranged opposite one another relative to a center of the element in a longitudinal direction. It should be understood that, but for their distinct orientation about a longitudinal axis, the longitudinal ends or sides 13, 15 of the element 10 may be identical to one another. Thus, the applicable descriptions herein will apply equally to either side 13, 15. The sides 13, 15 may be discrete elements each having a body 12 operatively connected to one another, or the sides 13, 15 may be formed as a single element having a common body 12. While the exemplary embodiment includes two replaceable ends 50, it should be understood that the number of replaceable ends may be varied (e.g., 1, 3, etc.) without departing from the scope of the present disclosure. Further, while the exemplary ends 50 are each removeable, in other embodiments, one or more ends or tips may be irremovably fixed to the main body 12 (e.g., formed integrally therewith or bonded thereto).

The main body 12 defines a centrally located, generally circular opening or drive feature 14 adapted to receive, for example, a drive spindle of a material processing machine. One or more keyways or splines may be defined within the opening 14 for engaging with corresponding drive keys or keyways of the spindle of the machine for driving the element 10 in a rotational manner. The main body 12 further includes tapered faces 11 defining portions of leading edges or working surfaces of the element 10. Likewise, the replaceable ends 50 may each include tapered faces 51 defining a remaining portion of a respective one of the leading edges of the element 10. Specifically, the tapered faces 51, 11 of each end 50 and the main body 12 define a continuous, uniform leading edge of the element 10 with the ends attached to the main body. In this way, the element 10 may be directional in nature (i.e., adapted to spin in a one direction during operation). As illustrated, the tapered faces 11 are formed only on each distal end of the exemplary main body 12. In other embodiments, the tapered faces 11 may extend over the entire length of each side 13, 15 of the element 10 (i.e., one-half of a total length of the element). In still other embodiments, no portion of the leading edges of the element 10 may be defined by the main body 12, rather, they may be defined only by the ends 50.

As shown in FIG. 1, the lateral sides of the element 10 opposite the leading edges in a width direction W may comprise trailing sides or edges 17 which may be oriented generally vertically between top and bottom surfaces of the main body 12 and/or the ends 50, and which may not define a taper. In other embodiments, the tapered leading edges of the element 10 may be formed on each lateral side thereof. In this embodiment, the element 10 may be used to act upon or process material in both rotational directions without the need to reorient the element relative to the machine.

Still referring to FIG. 1, in some embodiments, a width of the main body 12 and the ends 50 in the width direction W may be generally constant over the length of the element 10. In other embodiments, however, the width of the element 10 may taper along its length in each outward radial direction from the center or opening 14. The same may be true for a thickness of the element 10 (i.e., it may be constant, tapered, or otherwise varying). Further, in the exemplary illustrated embodiment, each end 50 defines only a portion of the tip or free end of the element 10 in the width direction W. This embodiment may be mechanically advantageous in that forces acting generally normal to and upon the tapered face 51 of the end 50 are directly opposed by the main body 12, relieving stress or strain on the mounting elements by which the end is fixed to the main body. In other embodiments, however, each end 50 may form the entire tip of the distal end of the element 10 in the width direction W.

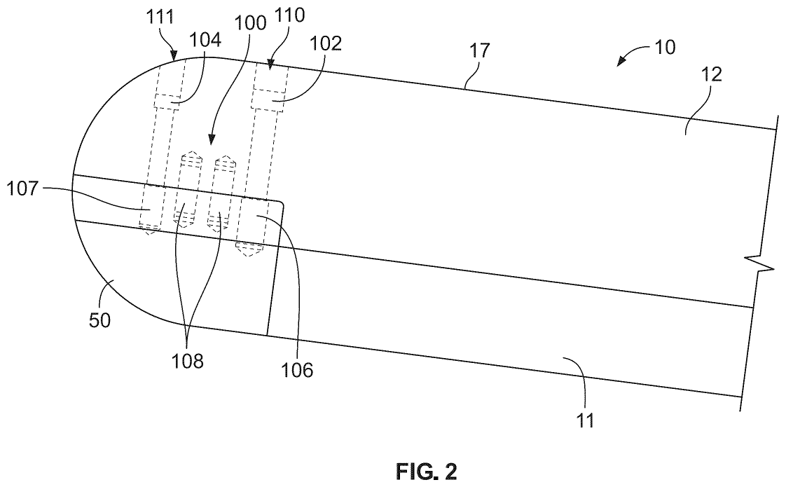

Referring now to FIGS. 2-4, an exemplary mounting system or arrangement 100 for attaching each end 50 to the main body 12 of an element 10 according to a first embodiment is shown. Specifically, the system 100 includes a plurality of mounting elements including a first fastener 102 (e.g., a socket head fastener or cap screw), a second fastener 104 (e.g., a second socket head screw), a pair of inserts 106, 107 (e.g., threaded invar plugs) and a pair of locating pins 108 (e.g., slotted spring pins) arranged between the first and second fasteners 102, 104. The main body 12 defines two through holes 110, 111 formed in the trailing edge 17. As illustrated, each through hole 110, 111 may be counterbored or countersunk for accepting the head of each of the fasteners 102, 104.

A pair of corresponding openings 151, 152 are formed in the end 50 and are coaxially aligned with the through holes 110, 111. The inserts 106, 107 are arranged in respective ones of the openings 151, 152, and are adapted to receive and threadably engage with ends of each of the fasteners 102, 104. The use of the metallic inserts 106, 107, and specifically invar inserts, provides temperature stable, high-strength threaded components to which the fasteners 102, 104 may be repeatedly removably (i.e., threadably) engaged. In one embodiment, the first fastener 102 is larger (e.g., longer and/or greater in diameter) compared to the second fastener 104. This may be enabled by a tapering of a thickness and/or the width of the element 10 approaching its ends.

The pair of pins 108 are arranged in openings 112, 113 defined into the body 12 and corresponding coaxially aligned openings 153, 154 defined into the element 50. The pins 108 serve to accurately locate the end 50 relative to the body 12, as well as provide additional strength and stability to the mounting system 100. Further, the pins 108 allow the end 50 to be fitted to the body 12 in an accurate position prior to the insertion and engagement of the threaded fasteners. This improves the ease of assembly of the element 10 (e.g., during replacement). As set forth in greater detail herein, it should be recognized by one skilled in the art that only one pin 108 may be used instead of two, or no pins in still other embodiments.

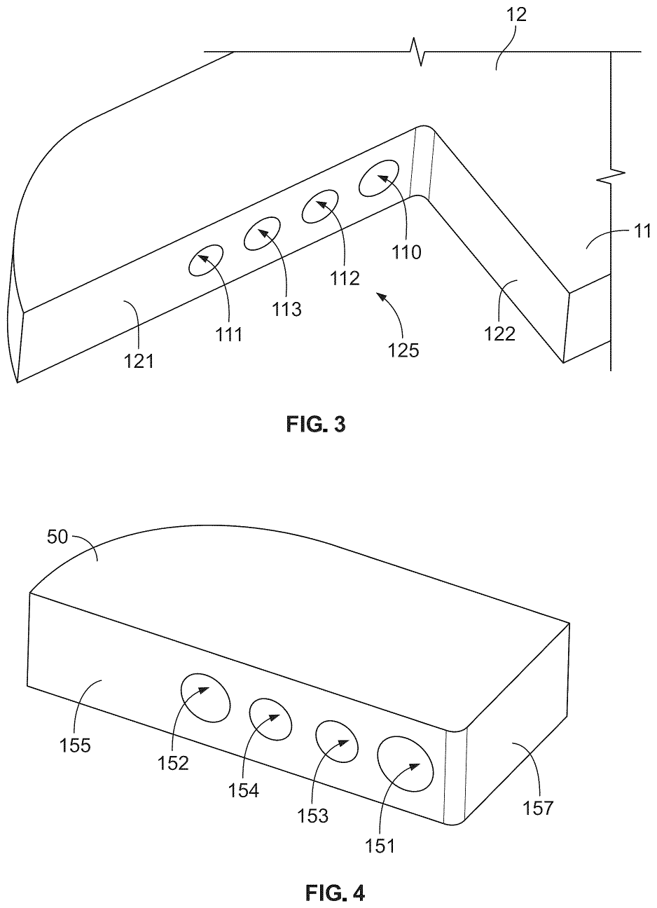

As shown in FIGS. 3 and 4, the through holes 110, 111 and the openings 112, 113 open onto a generally vertical sidewall or mating surface 121 of the body 12. The sidewall 121 extends generally in a longitudinal or length direction of the body 12. A second vertical sidewall or mating surface 122 is oriented generally perpendicularly to the sidewall 121, and extends generally in the width direction W of the body 12. It should be recognized by one skilled in the art that the angle between sidewalls 121 and 122 could be acute or obtuse as well. The first and second sidewalls 121, 122 define a cavity 125 sized to receive, or complementary to, the end 50. Likewise, the end 50 defines corresponding vertical sidewalls or mating surfaces 155, 157, which abuttingly oppose respective ones of the sidewalls 121, 122. As shown, each of the openings 151, 152, 153, 154 opens onto the sidewall 155 for coaxially aligning with the through holes 110, 11 and the openings 112, 113 of the body 12.

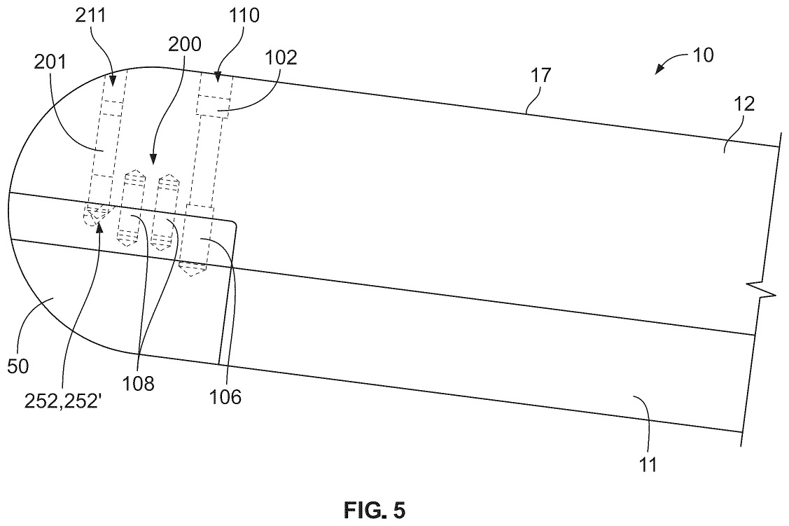

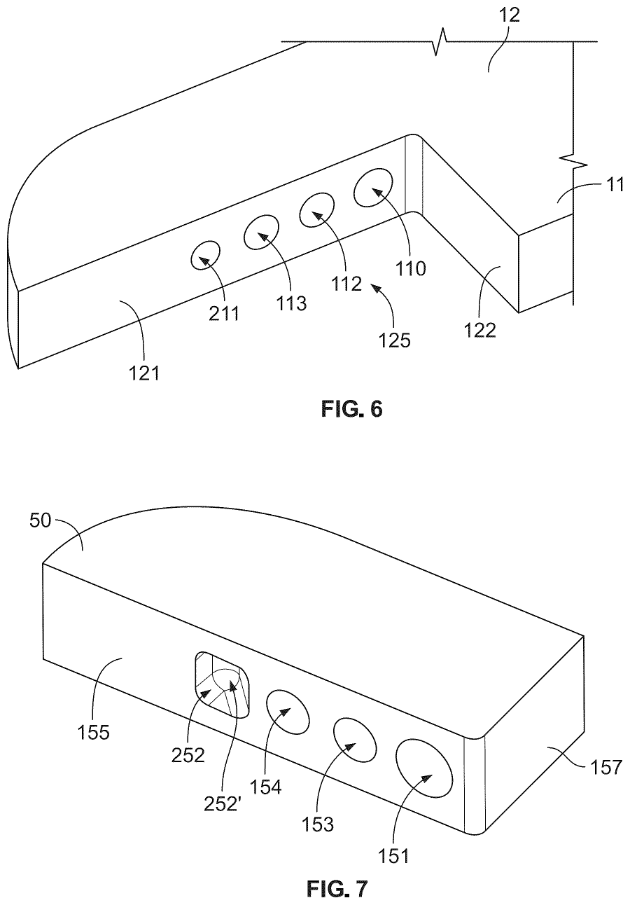

Referring now to FIGS. 5-7, another embodiment of a mounting system or arrangement 200 for attaching the end 50 to the main body 12 of the element 10 is shown. Like the embodiment, of FIGS. 2-4, the system 200 comprises a plurality of mounting elements including the threaded fastener 102, the pair of locating pins 108, and the same associated through hole 110 and openings 112, 113, 151, 153, 154 described above. The second threaded fastener 104 and the associated insert 107 of the previous embodiment has been replaced with a set screw 201. Specifically, the counterbored through hole 111 of the previous embodiment has been replaced with a threaded through hole 211 into which the set screw 201 is threadably engaged. The end 50 defines a corresponding coaxially aligned opening 252 adapted to receive the end of the set screw 201. In one embodiment, the set screw 201 defines a cone-shaped head, and the opening 252 defines a correspondingly tapered opposing face or bottom wall 252′, as shown in FIGS. 5 and 7. Like the embodiment of FIGS. 2-4, each of the openings and through holes are formed into and/or open onto the same opposing sidewalls 121, 155 of the main body 12 and end 50.

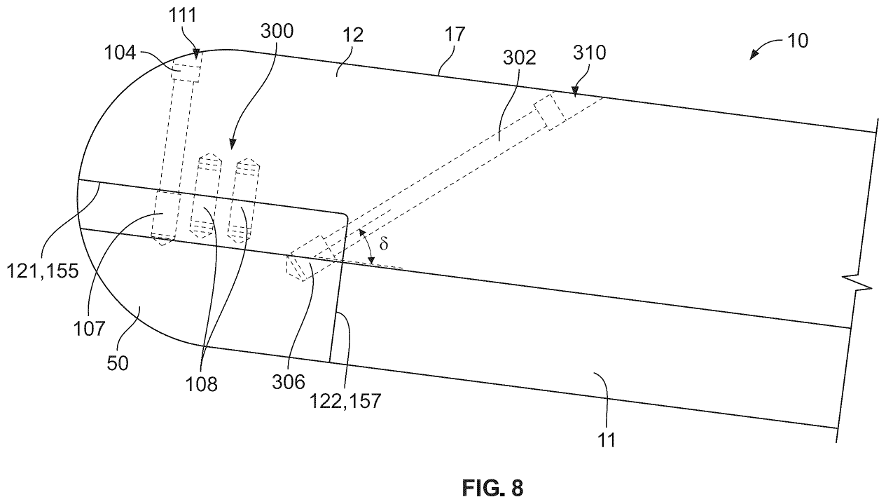

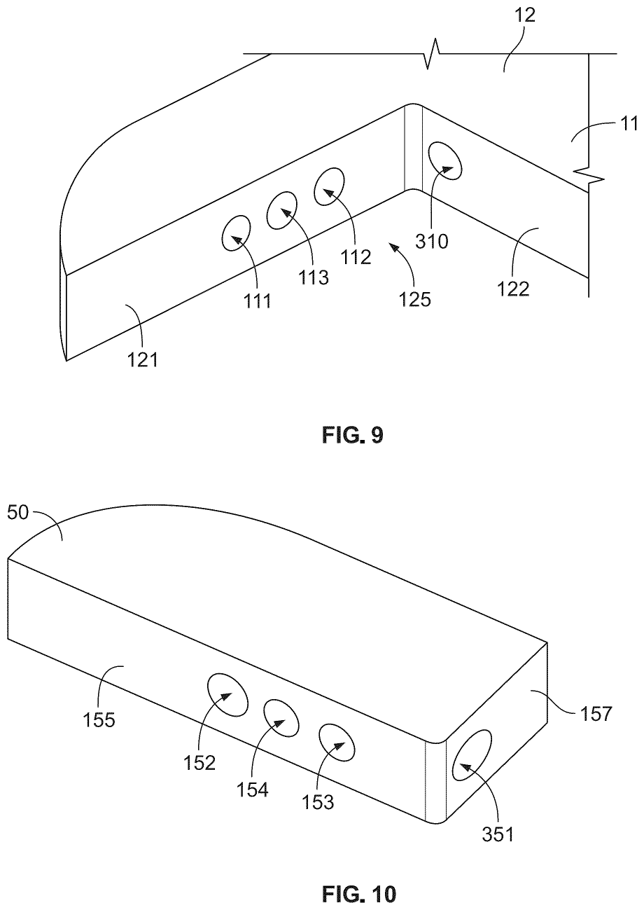

FIGS. 8-10 illustrate another embodiment of a mounting system or arrangement 300 for attaching the end 50 to the main body 12 of the element 10. The system 300 comprises a plurality of mounting elements including the same second threaded fastener 104 and corresponding through hole 111, as well as the opening 152 and the insert 107 according to the embodiment of FIGS. 2-4. Similarly, the pins 108 and corresponding openings 112, 113 and 153, 154 of the main body 12 and the end 50 are also provided. The first fastener of the embodiment of FIGS. 2-4 has been replaced with a fastener 302.

The fastener 302 extends in an oblique or angled orientation relative to the width and/or length direction of the element 10. In one embodiment, a counterbored through hole 310 is formed through the body 12 from the trailing edge 17 toward the end 50 at an angle δ of approximately 45 degrees from a longitudinal axis of the element 10. A corresponding coaxially aligned opening 351 is formed into the element 50, and is similarly fitted with an invar or metallic insert 306 adapted to threadably engage with the fastener 302. The angled nature of the fastener 302 provides additional tractive force on the end 50, drawing the sidewalls 122, 157 into abutting contact in a manner not realized by the embodiments of FIGS. 2-7. Thus, the embodiment of FIGS. 8-10 provides a means to generate compressive force between each of the pairs of opposing sidewalls 121, 122, 155, 157, improving the strength and stability of the connection between the end 50 and the body 12.

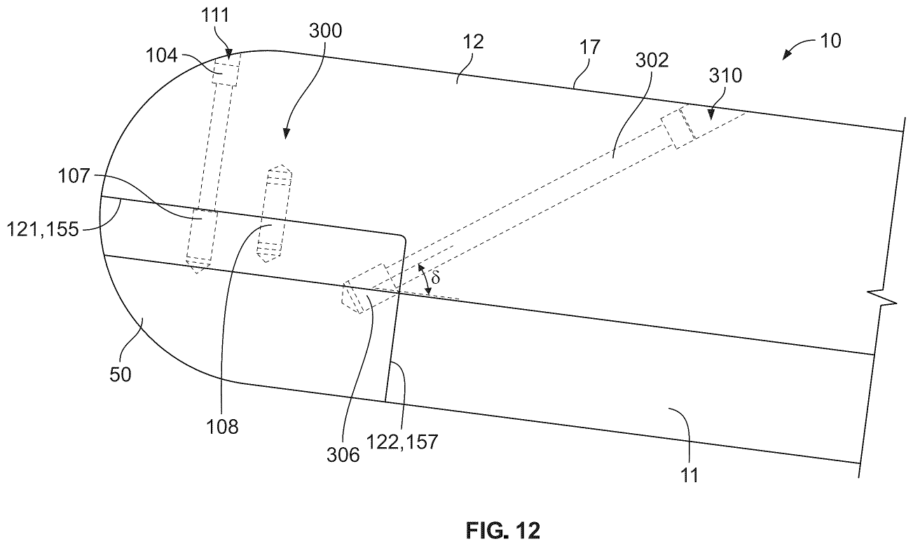

Similarly, the embodiment of FIG. 12 includes features similar to those set forth above with respect to FIGS. 8-10, and specifically a plurality of mounting elements including the threaded fastener 104 and the obliquely oriented fastener 302. However, unlike the pair of pins 108 utilized in the embodiment of FIGS. 8-10, only a single pin 108 is provided between the fasteners 104, 302. As with the previous embodiments, the pin 108 is arranged between the opposing sidewalls 121, 155, and provides similar strength, stability and positioning benefits. However, this configuration simplifies manufacturing, assembly and replacement operations, as well as lowers overall component and production costs.

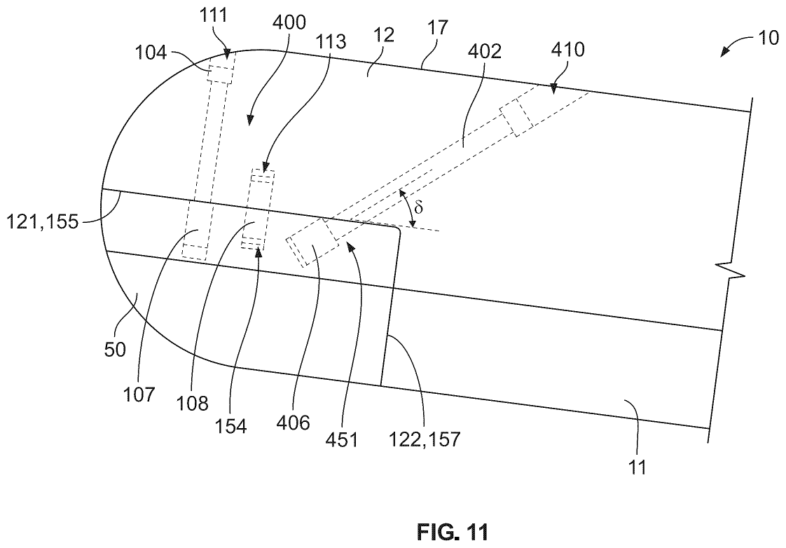

A further improved embodiment of a mounting system or arrangement 400 for attaching the end 50 to the main body 12 of the element 10 is shown in FIG. 11. Like the embodiment of FIGS. 8-10, the system 400 comprises a plurality of mounting elements including the second threaded fastener 104 and corresponding through hole 111, the opening 152, and the insert 107. The system 400 also includes one of the pins 108 and its corresponding openings 113, 154 formed into the body 12 and the end 50, respectively.

Like the previous embodiment, the system 400 includes a fastener 402 oriented obliquely (e.g., at an angle δ of approximately 45 degrees) relative to the width and/or length direction of the element 10. However, unlike the system 300, in which the through hole 310 and opening 351 open onto the vertical sidewalls 122, 157, respectively, a counterbored through hole 410 and a coaxially aligned opening 451 open onto the opposed sidewalls 121, 155 of the body 12 and the end 50, respectively. In this way, all of the openings and through holes are formed into, or open on, the same sidewall 121, 155 of each of the body 12 and the end 50. This simplifies the manufacturing process of the system 400, while retaining the benefits of applying a tension force onto the end 50 which draws it into abutting contact with each of the opposing sidewall pairs 121, 155 and 122, 157. As shown, the opening 451 of the end 50 may also be fitted with a metallic insert 406, such as an invar insert, adapted to threadably receive an end of the fastener 402.

In each of the above embodiments, it should be understood that the fastener through holes and corresponding threaded fasteners may define a complementary shoulder and head, respectively, such that the depth of insertion of the fastener into the body 12 is limited. In this way, tightening or threading the fastener into the insert of the end 50 is operative to draw the end 50 in at least one direction (i.e., the width direction) of the element 10, and in the embodiments of FIGS. 8-11, in two directions (i.e., the width direction and the longitudinal direction) of the element 10. As a threaded connection secures the end 50 to the main body 12, embodiments of the present disclosure provide a means to adjust the holding force securing the end to the main body. This is advantageous in that, depending on the differences in coefficients of thermal expansion between the ends 50 and the main body 12 of the element 10, any loosening of the ends relative to the main body may be addressed via periodic retorquing or tightening of the fastener(s).

In each of the embodiments, a first end of each of the through holes is adapted to receive a tool for rotating or otherwise engaging the fastener with the end 50. The first end of each of the through holes exits the second lateral or trailing side 17 of the main body 12 opposite the leading edge side. In this way, material(s) being processed by the element 10 is not forcibly introduced into the opening or through hole during operation, nor must the element 10 be removed from the machine in order to access the fastener for removal of the end(s) 50. This improves reliability and cleanliness, and increases operational efficiency, as the ends 50 may be replaced with greater ease.

In the embodiments of FIGS. 8-11, the lateral side exit of the through hole is achieved by offsetting a central axis of the through holes 310, 410 from a central axis of elongation of the main body 12 by an exemplary non-zero angle δ (i.e., they are oriented obliquely or non-parallel with one another), such as a 45 degree angle. This ensures that relatively even and/or uniform clamping or compressive force is generated between the abutting sidewalls of mating surfaces/faces of the end 50 and the main body 12.

As set forth above, the end 50 may be formed of a first monolithic material such as carbide, while the inserts are formed from, for example, stainless steel, invar or other metallic material. The inserts may be secured within the end 50 via any suitable means, including bonding or brazing. In some embodiments, a thread insert (e.g., a helical insert or HELI-COIL ®) may be provided within the openings or the inserts for forming and/or adding strength to the threaded connection between the end 50 and the threaded fasteners. In other embodiments, a separate thread insert may not be necessary, as the inherent strength of the insert material may be sufficient to provide a strong, reliable connection with the fastener (i.e., sufficient resistance to pull-out forces).

In some embodiments, the locating pins may be press fit, friction fit, slip fit, or threadably fit into either of the corresponding openings formed in the body 12 and the end 50. The pins may be straight pins or may be tapered along their length (or in each direction from a center thereof).

Further, it should be understood that the overall shape of the element 10 shown in the figures is only exemplary in nature, and may be varied without departing from the scope of the present disclosure. For example, the distal or free end sides of each of the removable ends or tips 50 may be rounded in nature (as shown), or may be squared-off or linearly angled. Likewise, the replaceable ends or tips 50 may be generally flat or planar relative to the main body 12 (as illustrated), or may be curved at least one of vertically upward or downward (i.e., toward a parallel relationship with a rotational axis of the element. In still other embodiments, the ends may extend obliquely upward and/or downward from the main body.

Elements according to embodiments of the present disclosure are generally adapted for use in material processing operations, including but not limited to, mixing, dispersing, cutting, milling, hammering, and/or agitating processes involving one or more materials (e.g., solid, liquid, and/or semiliquid materials). Likewise, while the elements (e.g., mixing elements) described herein may be generally referred to as impellers, it should be understood that this term includes blades, paddles, hammers, knives or other similar elements or tooling adapted to process (e.g., mix) one or more materials.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An impeller, comprising:
a body adapted to be operatively coupled to a material processing machine;
a tip removably attached to the body, the body and the tip defining:
a first lateral side including a leading edge adapted to impact a material to be mixed; and
a second lateral side opposite the first lateral side; and
a plurality of mounting elements removably fixing the tip to the body, at least a portion of the mounting elements extending through the body from the second lateral side and engaging with the tip.

2. The impeller of claim 1, wherein the plurality of mounting elements include:
a first threaded fastener arranged in a first through hole formed through the body and engaging with a corresponding first fastener opening defined in the tip; and
a first locating pin arranged between the body and the tip, the pin arranged in respective coaxially aligned first pin openings formed in the body and the tip.

3. The impeller of claim 2, wherein the body defines a first mating surface and the tip defines an opposing second mating surface.

4. The impeller of claim 3, wherein:
the first through hole and the first pin opening formed in the body open onto the first mating surface; and
the first fastener opening and the first pin opening formed in the tip open onto the second mating surface.

5. The impeller of claim 4, wherein the plurality of mounting elements further include a second threaded fastener arranged in a second through hole formed through the body and engaging with a corresponding second fastener opening defined in the tip.

6. The impeller of claim 5, wherein:
the body defines a third mating surface oriented transverse to the first mating surface and the tip defines an opposing fourth mating surface oriented transverse to the second mating surface; and
the second through hole opens onto the third mating surface and the second fastener opening opens onto the fourth mating surface.

7. The impeller of claim 6, wherein the first and second mating surfaces are oriented perpendicular to the third and fourth opposed mating surfaces.

8. The impeller of claim 6, wherein the second threaded fastener, the second through hole and the second fastener opening are oriented and extend obliquely relative to the first and second opposed mating surfaces and the third and fourth opposed mating surfaces.

9. The impeller of claim 8, wherein the second threaded fastener, the second through hole and the second fastener opening are oriented at an angle of approximately 45 degrees relative to the third and fourth opposed mating surfaces.

10. The impeller of claim 5, wherein the first locating pin and the coaxially aligned first pin openings formed in the body and the tip are oriented and extend generally perpendicular to the first and second opposed mating surfaces.

11. The impeller of claim 5, wherein the first and second threaded fasteners, the first and second through holes, the first locating pin, and the first pin opening extend generally perpendicular to the first and second opposed mating surfaces.

12. The impeller of claim 5, wherein:
the second through hole formed in the body opens onto the first mating surface; and
the second fastener opening opens onto the second mating surface.

13. The impeller of claim 5, wherein the plurality of mounting elements further include an insert arranged in each of the first and second fastener openings of the tip, each of the first and second fasteners threadably engaging with a respective one of the inserts.

14. The impeller of claim 13, wherein the inserts are formed from invar.

15. The impeller of claim 5, wherein the first and second threaded fasteners are cap screws and the first and second through holes define counterbores receiving a head of each of the cap screws.

16. The impeller of claim 1, wherein the tip is formed from at least one of tungsten carbide or ceramic.

17. An impeller assembly, comprising:
a metallic body adapted to be operatively coupled to a material processing machine;
a carbide or ceramic tip removably attached to the body, the body and the tip defining:
a first lateral side including a leading edge adapted to impact a material to be processed; and
a second lateral side opposite the first lateral side; and
a plurality of mounting elements removably fixing the tip to the body, including:
a first threaded fastener extending through the body from the second lateral side and engaging with the tip; and
a second threaded fastener extending through the body from the second lateral side and engaging with the tip.

18. The assembly of claim 17, further comprising a locating pin arranged between the body and the tip, wherein:
the body defines a first mating surface and a second mating surface;
the tip defines a third mating surface and a fourth mating surface opposing a respective one of the first mating surface and the second mating surface of the body;
the first threaded fastener is arranged in a first through hole formed through the body and engages with a corresponding first fastener opening defined the tip;
the second threaded fastener is arranged in a second through hole formed through the body and engages with a corresponding second fastener opening defined the tip; and
the locating pin is arranged in respective coaxially aligned first pin openings formed in the body and the tip.

19. The assembly of claim 18, wherein:
the first through hole opens onto the first mating surface of the body;
the second through hole opens onto the second mating surface of the body;
the first fastener opening opens onto the third mating surface of the tip; and
the second fastener opening opens onto the fourth mating surface of the tip.

20. The assembly of claim 19, wherein:
the first mating surface of the body and the third mating surface of the tip are oriented transverse to the second mating surface of the body and the fourth mating surface of the tip; and
the first fastener is oriented obliquely relative to the second fastener.
